(19) United States
(12) Patent Application Publication
(10) Pub. No.: US 2026/0347028 A1
(43) Pub. Date: Nov. 5, 2026

(54) CAPPING MACHINE FOR APPLYING PRE-THREADED CAPS PROVIDED WITH A SAFETY ASSEMBLY

(71) Applicant: AROL S.P.A., Canelli (AT) (IT)

(72) Inventors: Marco FORNO, Canelli (AT) (IT); Fabio PREGNO, Canelli (AT) (IT); Manuel SORCE, Canelli (AT) (IT)

(21) Appl. No.: 19/109,754

(22) PCT Filed: Sep. 8, 2023
(86) PCT No.: PCT/IB2023/058905

§ 371 Date: Mar. 7, 2025

(30) Foreign Application Priority Data
Sep. 9, 2022 (IT) 102022000018459

(51) Int. Cl. B65B 7/28

(52) U.S. Cl. CPC B65B 7/2835

(57) ABSTRACT

A capping machine for applying pre-threaded caps to containers is provided and comprises one or more capping heads in which a linear actuator and a rotary actuator apply to a shaft a rotary movement about its axis and a translational movement along the axis, and a safety assembly for keeping the shaft of a head raised in case of a malfunctioning of the linear actuator. The safety assembly includes a cam and, on each head: a cam follower roller; a first stop member carried by a first translating assembly; and a second stop member, which is mounted on a second translating assembly associated with the linear actuator and integral for the translational movement with the shaft, and which is arranged to engage the first stop member to stop downward translation of the shaft when the latter attains a limit position indicating a malfunctioning.

### TECHNICAL FIELD

This invention relates to capping installations and, more particularly, it concerns a capping machine for applying pre-threaded caps provided with a safety assembly.

### BACKGROUND ART

As known, capping machines generally include a movable support moving a plurality of capping heads by following a path along which the containers are conveyed. For instance, the capping heads are mounted on the periphery of the support that is made to rotate so as to sequentially bring the heads and the containers to a capping position. While being moved by the movable support, the capping heads are made to vertically move downwards in order to reach the mouth of the container to be capped and to rise again once capping is over. Moreover, in case of application of pre-threaded caps (or screw caps), the capping heads are also made to rotate in order to tightly close the cap on the container mouth.

The translational movement can be obtained by means of a mechanical cam extending along the whole of the path run by the movable support. Each capping head is equipped with a roller constrained to roll onto the mechanical cam and to follow the profile thereof, thereby causing the translation of the remaining head components. As an alternative to using a mechanical cam, the translational movement can be obtained by means of an electronic or “virtual” cam: in this case, it is the control system of the machine that controls at any instant, by means of suitable electrical actuators, the vertical position of the head, by simulating the action of a mechanical cam and of the roller associated with the head.

The invention concerns capping machines of this latter type.

Virtual cam capping machines are generally provided with safety devices intervening in case of a malfunctioning of the virtual cam that could cause an anomalous descent of the rotating and translating shaft of a head and the consequent impact of the same shaft against other parts of the capping machine, such as for instance the mechanism for picking and applying the caps, the caps guides, the carrousel feeding the containers to be capped to the capping machine and so on, with consequent risks for the integrity of the capping machine and the safety of the workers.

EP 2669243 A1 and WO 2021/136581 disclose apparatuses for filling containers having an emergency cam system intervening in case of malfunctioning and forcing the apparatus to an inactive position.

EP 3819256 A1 discloses a virtual cam capping device having a linear motor and a rotary motor for driving the translational and rotary movements and including a cam system acting as an emergency raising means for the capping device in case a malfunctioning occurs, and a magnet suspension system arranged to keep the rotary motor in a position raised relative to the working position even when the linear motor is switched off or electro-magnetically decoupled.

Virtual cam capping machines are also known where the heads include springs maintaining them in raised position in case the heads are turned off, even if the turning off is not due to safety reasons. Yet, such capping machines have the drawback that, during operation, the resistance of the springs has to be periodically overcome.

A commercially available linear-rotary actuator can be associated, in a region of an utilisation apparatus where, in case of a malfunctioning, an impact of the rotating and translating shaft with other moving parts is possible, with a safety system intended to keep the shaft raised and including a cam with which a roller carried by the shaft engages. See https://www.cmafh.com/images/Master%20PDFs/LinMot/0185-0015E_2V96_IG_Linear_Rotary_Motors_PR01-reduced.pdf. Such an actuator has been tested also in capping machines. This solution has a number of drawbacks. The most serious drawback is that, when the safety cam is to come into operation, an impact of the roller against the cam occurs, resulting in the generation of strong tangential forces, and the rising movement of the linear actuator is to be performed by operating on two uprights having guiding and anti-rotation functions.

### DESCRIPTION OF THE INVENTION

It is an object of the present invention to provide a capping machine with a virtual cam capping heads and a capping method obviating the drawbacks of the prior art.

In a first aspect of the invention, there is provided a capping machine for applying pre-threaded caps to containers, including a safety assembly including a cam and arranged to keep the shaft of a head raised in case of a malfunctioning of the linear actuator of the head, wherein the cam has at least one track extending over the whole extension of a path run by the head(s) of the capping machine during a capping cycle, and wherein the safety assembly further includes, on each capping head:
a cam follower roller that is arranged to roll in contact with the track over the whole of said path and is mounted on a first translating assembly, associated with the linear actuator, in such a manner that the first translating assembly and the linear actuator can perform a translational movement relative to each other while the shaft is performing the translational and rotary movements required by a capping operation;
a first stop member carried by the first translating assembly; and
a second stop member, which is mounted on a second translating assembly also associated with the linear actuator and integral for the translational movement with the shaft, and which is arranged to engage the first stop member to stop downwards translation of the shaft when it attains a limit position, the attainment of which indicates a malfunctioning.

Advantageously, the first translating assembly is mounted at the end of a piston arranged, during the rotary movement of the shaft, to rotate within a sleeve slidable relative to an actuator support, and the second translating assembly includes an L-shaped bracket the vertical arm of which carries the second stop member and the horizontal arm of which is fastened to a rod slidable inside the linear actuator and integral with the shaft.

According to an advantageous feature of the invention, the safety assembly further includes a first sensor arranged to recognise the attainment of the limit position and, in such condition, to switch off the power supply to the actuators.

Preferably, the first sensor is a proximity sensor arranged to recognise the attainment of the limit position by detecting the passage of a surface of the second translating assembly opposite it.

Advantageously, the first sensor is located in a position, along the path of a head, in which the head starts rising from a bottom dead centre to a top dead centre of its translational movement at the beginning of a capping cycle, and is mounted in a position that is at least horizontally, and preferably both horizontally and vertically adjustable.

According to an advantageous feature of the invention, the safety assembly further includes a second sensor for detecting the degree of wear of the cam follower roller, and said second sensor detects the degree of wear of the cam follower roller by cooperating with a counterpart carried by the first translating assembly.

In another aspect, the invention also concerns a method of capping containers with pre-threaded caps by using the capping machine described above, and comprising the steps of:
associating with the capping machine a mechanical cam having at least one track extending over the whole extension of a path run by the head(s) during a capping cycle and defining a lower limit for the position of the shaft during said cycle;
equipping the or each head with a cam follower roller associated with the linear actuator so that such two parts can perform a translational movement relative to each other while the shaft is performing the translational movement;
keeping the cam follower roller in engagement with said track over the whole of said path;
detecting the vertical position of the shaft in at least one predetermined position along said path; and
stopping a downward translation of the shaft when it reaches the limit position.

### BRIEF DESCRIPTION OF DRAWINGS

The above and other features and advantages of the present invention will become apparent from the following description of a preferred embodiment made by way of non-limiting example with reference to the accompanying drawings, in which elements denoted by a same or similar reference numeral correspond to components having the same or similar function and construction, and in which:

FIG. 1 is an isometric view of a capping turret according to the invention;

FIG. 2A is an enlarged isometric view showing a capping head of a turret according to the invention and the safety assembly;

FIG. 2B is an enlarged side view showing a capping head of a turret according to the invention and the safety assembly;

FIG. 3 is an enlarged view in vertical cross section of a detail of the safety assembly;

FIG. 4 is an enlarged partial view showing the safety assembly in conditions of regular operation of a head;

FIG. 5 is an enlarged partial view showing the safety assembly in conditions of malfunctioning of a head;

FIG. 6 is a graph showing two exemplary profiles of a virtual cam and a profile of the safety cam employable for both profiles;

FIG. 7 is an isometric view of part of a turret according to the invention, showing the sensor detecting an anomalous descent of the heads; and

FIG. 8 is a view in enlarged scale of the sensor shown in FIG. 7.

### DESCRIPTION OF EMBODIMENTS

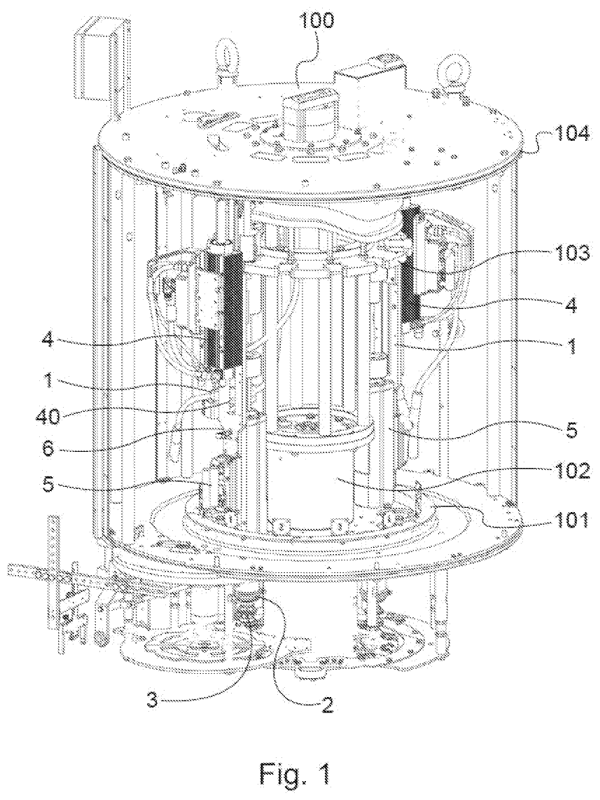

Referring to FIG. 1, there is schematically shown a rotary capping machine or turret 100 according to the invention for applying screw caps on containers such as bottles, vials etc.

Turret 100 has a plurality of heads 1 carried by a platform 101 integral with a shaft 102 with vertical axis that is made to rotate about its axis to pick the containers to be capped (not shown in the Figure), bring the containers and the heads to a capping position and then bring the capped containers to a position of removal from capping machine 100. Heads 1 are mounted on platform 101 so that the capping axis is parallel to the axis of shaft 102 and, during rotation of turret 100, their upper end is trailed by a second platform 103, parallel to platform 101 and also integral with shaft 102. The lower end of rotating and translating shaft 2 is associated with members 3 for gripping/releasing the caps.

As known, during rotation of turret 100, heads 1 perform, at each capping cycle, an axial translational movement between a bottom dead centre and a top dead centre and vice versa, and a rotary movement about their axis in order to screw the cap onto the container. The axial translational movement and the rotary movement of each head 1 are obtained by means of a first electronic actuator 4 (linear actuator) operating according to the virtual cam concept discussed above, and a second electronic actuator 5 (rotary actuator), both controlled by the control unit of the capping machine, not shown. Both actuators are carried by a common support 6 having a longitudinal slot 40 the purpose of which will become apparent later on. The described structure is wholly conventional and hence it will not be described in more detail.

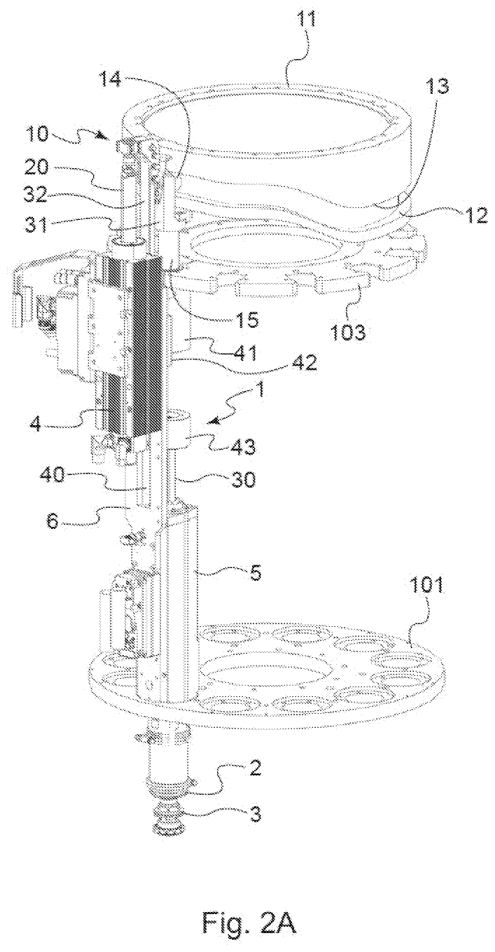

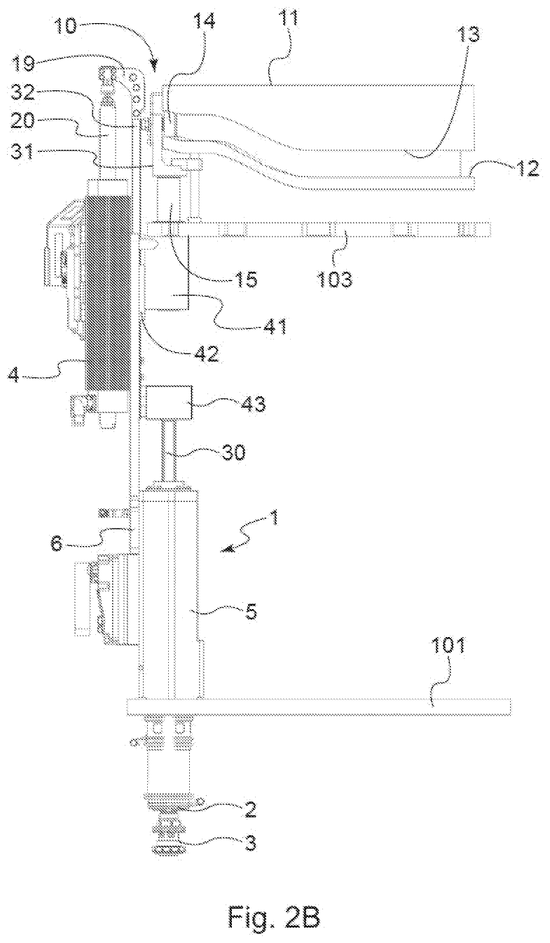

Referring now to FIGS. 2 to 5, according to the invention turret 100 is provided with a safety assembly 10 intervening in case of a malfunctioning of the virtual cam that could cause an anomalous descent of rotating and translating shaft 2 of a head 1 and the consequent impact of the same shaft against other parts of the capping machine (such as for instance the mechanism picking and applying the caps, the cap guides, the carrousel feeding the containers to be capped to turret 100 and so on) or, at least, could prejudice the good result of the capping operation. In the embodiment illustrated, in order to allow the operation of safety assembly 10, linear actuator 4 of each head 1 is off axis relative to the capping axis of the same head, whereas rotary actuator 5 is equipped with a slidable rod in axis with the capping axis.

Safety assembly 10 includes a substantially cylindrical mechanical cam 11 that is carried by a platform 104 stationary relative to turret 100 and has a track 12 extending over the whole circumference of cam 11 and on which a roller 14, advantageously made of rubber, permanently rolls. Track 12 constitutes a lower limit for the vertical position of rotating and translating shaft 2 during capping, such that shaft 2 cannot descend to such an extent as to interfere with the movements of the other parts of the turret. It is pointed out that cam 12 does not take part in the capping operations, the translational movement of heads 1 being controlled only by the software of the control unit (not shown), i.e. by the virtual cam.

The Figures also show an upper track 13, which however has no safety function and the provision of which is essentially due to technological reasons related to the construction of track 12. Upper track 13 can anyway serve to absorb jerks during particularly harsh accelerations.

FIG. 6 shows two exemplary profiles of the virtual cam, denoted V1 and V2, relating to caps with different heights and threads, and a possible profile of the safety cam, denoted S, for a whole rotation cycle of turret 100. Vertical lines denote the instants of transition between different operation phases, i.e. the instants at which a particularly law of motion starts being applied. The different operation phases are the standard phases, i.e.: start and rise (phase F1) in which, after a reset cycle, all linear actuators 4, starting from the bottom dead centre, denoted by line PMI, move to the top dead centre, denoted by line PMS; pause in the movement (phase F2); picking of the cap from the picking zone and cap positioning (phase F3); cap insertion into cone 3 (phase F4); approach to the container (phase F5); screwing (phase F6); return to the bottom dead centre PMI and pause in the movement in preparation to the subsequent cycle (phase F7).

The distance between the trajectory imparted by the virtual cam and track 12 of the safety cam changes at each phase and depends on the distance, in each phase, between shaft 2 and the other moving parts of turret 100. Such a distance will be minimum (even less than 1 mm) in the phases in which the shaft moves closer to non-rotating parts, for instance in cap picking phase F2 and at the bottom dead centre at the end of the cycle. Moreover, such a distance depends on the kind of cap. For a given kind of cap, it will be the greater the higher is the cap, since head 1 must rise in proportion to the cap height.

Reverting to FIGS. 2 to 5, roller 14 is carried by a first translating supporting assembly 31 associated with linear actuator 4 of head 1 in such a manner that the two components can perform a translational movement relative to each other during the translation and rotation of rotating and translating shaft 2 demanded by the capping. More particularly, supporting assembly 31 is mounted at the end of a piston 15 that, during the rotation of head 1, can translate and rotate within a stationary sleeve 41 integral with support 8. A plate 42 made of self-lubricating plastics makes sliding of supporting assembly 31 easier.

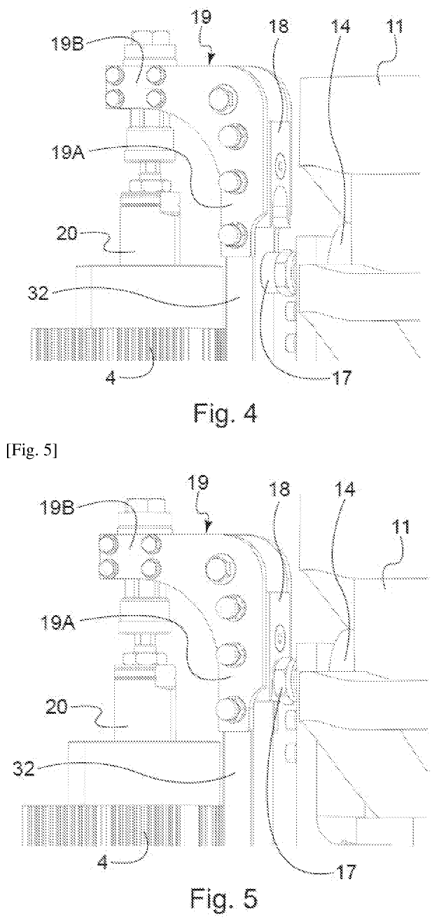

Roller 14 is mounted at one end of a pin 11 that, at the opposite end, carries a stop bushing 17 intended to cooperate with a dowel 18, advantageously made of self-lubricating plastics, which is carried by a second translating assembly 19 integral, for the translational movement, with rotating and translating shaft 2. This second assembly includes an L-shaped bracket 19 fastened to a rod 32 that, during the translation of rotating and translating shaft 2, slides on support 6, and hence relative to actuators 4, 5, thanks to slot 40 in support 6. Vertical arm 19A of bracket 19 has fastened thereto dowel 18, whereas horizontal arm 19B is mounted at the upper end of a rod 20 slidable inside linear actuator 4 and integral with shaft 2. In regular operation conditions of the virtual cam (FIG. 4) rod 20 is in such a position that dowel 18 always is at a distance from bushing 17, whereas in case of a malfunctioning causing an anomalous descent of shaft 2 down to a limit position (FIG. 5), dowel 18 will engage bushing 17 thereby preventing a further descent.

A decoupling joint 43 integral with rod 30 allows the movements of shaft 2 relative to rotary actuator 5.

It is to be appreciated that cam 11 and roller 14 do not impose limits to the upwards displacement of rotating and translating shaft 2. Moreover, roller 14 is carried by translating assembly 31, which is off-axis relative to linear actuator 4 so that rod 20 translating with shaft 2 does not interfere with cam 11.

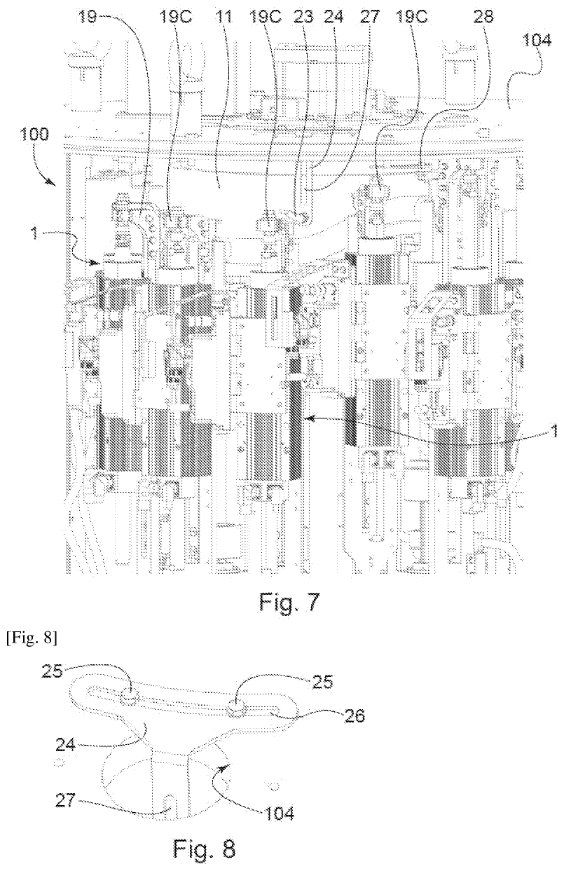

Referring to FIGS. 7 and 8, safety assembly 10 further includes a proximity sensor 23 intended to detect the presence of front surface 19C of arm 19B of bracket 19 in its operating range. Sensor 23 is carried by a bracket 24 with L-shaped cross section fastened to platform 104 and is mounted in a position that is at least horizontally adjustable. To this end, in its horizontal portion fastened to platform 104, bracket 24 has a slot 26 where pins or bolts 25 engage.

For a given cap, sensor 23 is arranged in a vertical position such that the presence of front surface 19C of arm 19B of bracket 19 in its operating range indicates an anomalous descent of head 1. The detection of such presence is communicated by sensor 23 to the control devices of turret 100 and makes them to switch off the power supply to actuators 4, 5 to prevent head 1 from starting again operating and performing movements of any kind. As a consequence of the switching off of the power supply, shaft 2 tends to further descend due to its own weight and dowel 18 comes into abutment with bushing 17 thereby stopping the descent, as stated above.

Sensor 23 is arranged on turret 100 in a position corresponding to the beginning of the up ramp in phase F1, since this is the zone where a descent dangerous for safety can occur. Theoretically, it would be therefore possible to provide a cam 11 extending only in the zone where the descent is possible, as in the commercial solution mentioned before. Yet, as said, such a solution has serious drawbacks.

It is to be noted that, in the embodiment shown in these Figures, sensor 23 is mounted in a vertically fixed position. Yet, also the possibility of a vertical adjustment can be envisaged, by mounting sensor 23 in a vertical slot 27 formed in the vertical portion of bracket 24. In this manner, by properly choosing the vertical position of sensor 23, the latter can intervene not only in case of a descent prejudicial to safety, but also in case of minor falls that however would prejudice the good result of the capping.

Such minor falls could occur also in other zones of the cycle. Yet, it is not necessary to provide further sensors similar to sensor 23 also in such other zones since, as known, virtual cam capping systems anyway have electronic controls, based on position feedbacks intrinsic in the linear electronic actuating system, which provide an instant analysis on the position error. It is then up to the control unit of turret 100 to intervene if the error exceeds a predetermined threshold, possibly by switching off also in this case the power supply to linear actuator 4 and hence making the concerned head to be guided on track 12 for the remaining part of the cycle.

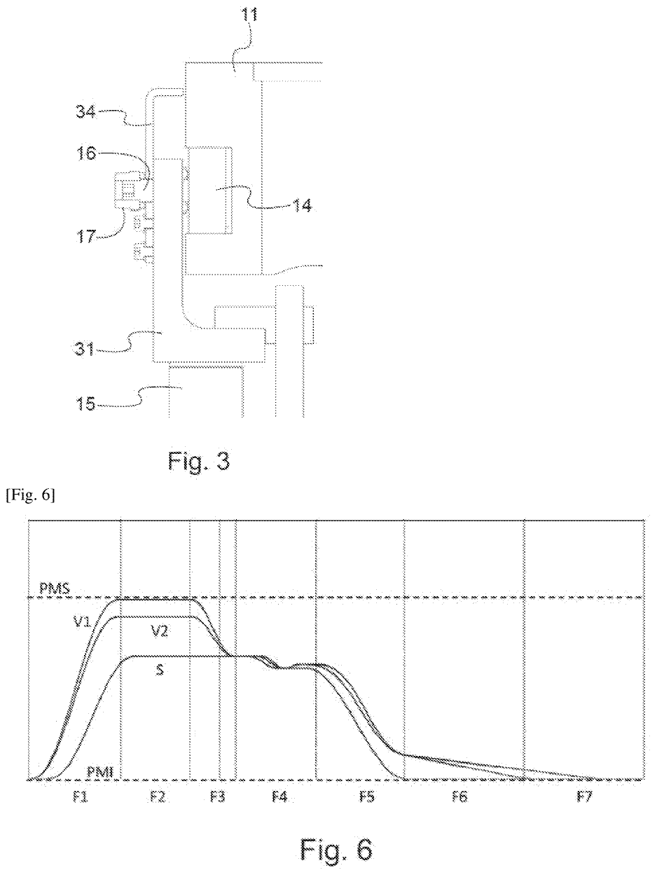

FIG. 7 also shows a sensor 28 for detecting the wear of roller 14, for instance of the type described in WO 2022023939 A1, which cooperates for such detection with an L-shaped bracket 34 (FIG. 3) carried by supporting assembly 31 of roller 14.

The invention actually solves the problems of the prior art. Indeed, the use of a cam 11 tracks 12 and 13 of which extend over the whole 360° of the rotation cycle of turret 100 and the engagement of roller 14 with the tracks over the whole of the path run by the heads eliminate the impact of the roller against the cam when the roller arrives in the region where such a cam is located. Moreover, such an arrangement provides support during the whole of the cycle to head 1 having been deactivated while the turret continues rotating to perform capping with correctly operating heads 1. Furthermore, the uprights having guiding and anti-rotation functions are not required.

It is clear that the above description is given only by way of non-limiting example and that changes and modifications are possible without departing from the scope of the invention.

More particularly, the mechanical components forming the translating assemblies and their association with the actuators can be replaced by components having the same functions.

Moreover, even if the drawings show a capping machine in which the linear axis and the rotary axis, corresponding to the axes of rods 20, 30 (FIGS. 2A, 2B. 4, 5), respectively, are offset relative to each other, it is possible to arrange them in alignment, by suitably dimensioning cam 11.

Still further, even if a turret capping machine has been disclosed, the invention can be applied also in the case in which the heads move along a rectilinear path during capping.

1. A capping machine (100) for applying pre-threaded caps to containers, comprising:
one or more capping heads (1) each including a shaft (2) that can perform a rotary movement about its axis and a translational movement along said axis, and a linear actuator (4) and a rotary actuator (5) for applying the translational and the rotary movements to the shaft (2) under the control of a control unit; and
a safety assembly (10) including a cam (11) and arranged to keep the shaft (2) of a head (1) raised in case of malfunctioning of the linear actuator (4) of the head;
characterised in that the cam (11) has at least one track (12) extending on the cam (11) over the whole extension of a path run by the head(s) (1) during a capping cycle; and in that the safety assembly (10) further includes, on each head (1):
a cam follower roller (14) that is arranged to roll in contact with the track (12) over the whole of said path and is mounted on a first translating assembly (31) associated with the linear actuator (4) so that such two parts can perform a translational movement relative to each other while the shaft (2) is performing the translational and the rotary movements;
a first stop member (16, 17) carried by the first translating assembly (31); and
a second stop member (18), which is mounted on a second translating assembly (19) also associated with the linear actuator (4) and integral for the translational movement with the shaft (2), and which is arranged to engage the first stop member (16, 17) to stop downwards translation of the shaft (2) when the latter attains a limit position, attainment of which indicates a malfunctioning.

2. The capping machine (100) according to claim 1, wherein the first translating assembly (31) is mounted at the end of a piston (15) arranged, during the rotary movement of the shaft (2), to translate and rotate within a stationary sleeve (41).

3. The capping machine (100) according to claim 1, wherein the second translating assembly (19) includes an L-shaped bracket (19) the vertical arm (19A) of which carries the second stop member (18) and the horizontal arm (19B) of which is fastened to a rod (20) slidable inside the linear actuator (4) and integral with the shaft (2).

4. The capping machine (100) according to claim 1, wherein the linear actuator (4) and the rotary actuator (5) are axially offset relative to each other to such an extent that the cam (11) and the first stop member (16, 17) do not interfere with the upward translation of the shaft (2).

5. The capping machine (100) according to claim 1, wherein the linear actuator (4) and the rotary actuator (5) are axially aligned and the cam (11) is sized and positioned relative to the shaft so that the cam (11) itself and the first stop member (16, 17) do not interfere with the upward translation of the shaft (2).

6. The capping machine (100) according to claim 1, wherein the safety assembly (10) further includes a first sensor (23) arranged to recognise the attainment of the limit position and to switch off, in such condition, the power supply to the actuators (4, 5), and wherein the first sensor (23) is a proximity sensor arranged to recognise the attainment of the limit position by detecting the passage of a surface of the second translating assembly (19) opposite it.

7. The capping machine (100) according to claim 6, wherein the first sensor (23) is located in a position, along the path of a head (1), in which the head starts rising from a bottom dead centre to a top dead centre of its translational movement at the beginning of a capping cycle.

8. The capping machine (100) according to claim 6, wherein the first sensor (23) is mounted in a position that is at least horizontally adjustable.

9. The capping machine (100) according to claim 1, wherein the safety assembly (10) further includes a second sensor (28) for detecting the degree of wear of the cam follower roller (14), and said second sensor (28) detects the degree of wear by cooperating with a counterpart (32) carried by the first translating assembly (31).

10. A method of capping containers with pre-threaded caps by using a capping machine (100) according to claim 1 having one or more capping heads (1) each including a shaft (2) that can perform a rotary movement about its axis and a translational movement along said axis, which movements are applied by a linear actuator (4) and a rotary actuator (5), respectively, electronically controlled by a control unit, the method being characterised in that it comprises the steps of:
associating with the capping machine (100) a mechanical cam (11) having at least one track (12) extending over the whole extension of a path run by the head(s) (1) during a capping cycle and defining a lower limit for the position of the shaft (2) during said cycle;
equipping the or each head (1) with a cam follower roller (14) associated with the linear actuator (4) so that such two parts can perform a translational movement relative to each other while the shaft (2) is performing the translational movement;
keeping the cam follower roller (14) in engagement with said track (12) over the whole of said path;
detecting the vertical position of the shaft (2) in at least one predetermined position along said path; and
stopping a downward translation of the shaft (2) when it reaches the limit position.

11. The capping machine (100) according to claim 2, wherein the second translating assembly (19) includes an L-shaped bracket (19) the vertical arm (19A) of which carries the second stop member (18) and the horizontal arm (19B) of which is fastened to a rod (20) slidable inside the linear actuator (4) and integral with the shaft (2).

12. The capping machine (100) according to claim 2, wherein the linear actuator (4) and the rotary actuator (5) are axially offset relative to each other to such an extent that the cam (11) and the first stop member (16, 17) do not interfere with the upward translation of the shaft (2).

13. The capping machine (100) according to claim 3, wherein the linear actuator (4) and the rotary actuator (5) are axially offset relative to each other to such an extent that the cam (11) and the first stop member (16, 17) do not interfere with the upward translation of the shaft (2).

14. The capping machine (100) according to claim 2, wherein the linear actuator (4) and the rotary actuator (5) are axially aligned and the cam (11) is sized and positioned relative to the shaft so that the cam (11) itself and the first stop member (16, 17) do not interfere with the upward translation of the shaft (2).

15. The capping machine (100) according to claim 3, wherein the linear actuator (4) and the rotary actuator (5) are axially aligned and the cam (11) is sized and positioned relative to the shaft so that the cam (11) itself and the first stop member (16, 17) do not interfere with the upward translation of the shaft (2).

16. The capping machine (100) according to claim 2, wherein the safety assembly (10) further includes a first sensor (23) arranged to recognise the attainment of the limit position and to switch off, in such condition, the power supply to the actuators (4, 5), and wherein the first sensor (23) is a proximity sensor arranged to recognise the attainment of the limit position by detecting the passage of a surface of the second translating assembly

(19) opposite it.

17. The capping machine (100) according to claim 3, wherein the safety assembly (10) further includes a first sensor (23) arranged to recognise the attainment of the limit position and to switch off, in such condition, the power supply to the actuators (4, 5), and wherein the first sensor (23) is a proximity sensor arranged to recognise the attainment of the limit position by detecting the passage of a surface of the second translating assembly (19) opposite it.

18. The capping machine (100) according to claim 4, wherein the safety assembly (10) further includes a first sensor (23) arranged to recognise the attainment of the limit position and to switch off, in such condition, the power supply to the actuators (4, 5), and wherein the first sensor (23) is a proximity sensor arranged to recognise the attainment of the limit position by detecting the passage of a surface of the second translating assembly (19) opposite it.

19. The capping machine (100) according to claim 5, wherein the safety assembly (10) further includes a first sensor (23) arranged to recognise the attainment of the limit position and to switch off, in such condition, the power supply to the actuators (4, 5), and wherein the first sensor (23) is a proximity sensor arranged to recognise the attainment of the limit position by detecting the passage of a surface of the second translating assembly (19) opposite it.

20. The capping machine (100) according to claim 7, wherein the first sensor (23) is mounted in a position that is at least horizontally adjustable.
